(19) United States
(12) Patent Application Publication
(10) Pub. No.: US 2007/0276970 A1
(43) Pub. Date: Nov. 29, 2007

(54) Data Consistency Validation

(75) Inventors: Thomas Werner, Baden (CH); Claus Vetter, Buchs (CH); Erik Svensson, Zurich (CH); Thomas Koch, Zurich (CH)

Correspondence Address: BUCHANAN, INGERSOLL & ROONEY PC, POST OFFICE BOX 1404, ALEXANDRIA, VA, 22313-1404, US

(73) Assignee: ABB Research Ltd., Zurich (CH)

(21) Appl. No.: 10/593,095

(22) PCT Filed: Mar. 17, 2004
(86) PCT No.: PCT/CH04/00158

§ 371 Date: Sep. 15, 2006

(51) Int. Cl. G06F 17/30

(52) U.S. Cl. 710/55

(57) ABSTRACT

Attribute consistency works on the comparison of a reference value against the online value of the attributes, which are retrieved from the corresponding system. In order to know which attributes need to be considered for consistency, a list of relevant attributes of each entity type in each application is stored together with the reference value of the entity. This attribute list is used by the consistency service. Therefore several attribute values of one entity in one system can be included in a combined “hash” value. At start-up or in the engineering phase, this reference value is computed out of the defined attribute list. At the time of a consistency check, the values of the attributes are read and a “hash” value is calculated with the same algorithm as the reference value. If those two values differ, an inconsistency occurred. The inventive method allows validating consistency of attributes of an entity in one of the participating applications. Any inconsistency can be propagated to all other participating applications which then may trigger functionality accordingly.

### FIELD OF THE INVENTION

The invention relates to the field of utility automation.

It relates to a method for validating consistency of entities stored in data sets of a multitude of different IT systems used for operating utility automation entities.

### BACKGROUND OF THE INVENTION

With the deregulation of energy markets, focus in utilities shifts towards optimizing the internal business processes. On the IT system side, navigation between, synchronization and retrieval of information stored in the various data sources in operation (e.g. SCADA—supervisory control and data acquisition, CMMS—computerized maintenance management systems, GIS—geographic information system) is a challenge.

All applications work on the same “world view”—physical assets in utility operations, such as stations, lines, transformers, breakers, regions and areas. These assets are modeled in the various applications and carry specific attributes with them. However, a consolidated access to this information is cumbersome and maintenance efforts for the data stores are huge. Examples here are network modifications, such as commissioning or disposals of assets, which subsequently imply changes in the IT application data sets.

To overcome the challenges of interoperability between the named systems, integration applications are being developed. One example is the cross-application navigation between the GUI of the participating applications in the same context. Another example is the uniform data access independent of underlying source applications.

As soon as relationships between entities in different data sources are defined, consistency of those relationships becomes a relevant issue for applications that rely on those relationships.

Today, a number of IT systems are in operation in utilities, with which the different facets of utility operations are managed: a SCADA system carries an electrical view on assets (electrical network) in order to open/close breakers, monitor voltages, currents or capacity limits. CMMS, such as SAP PM and GIS, such as ESRI, are used for maintenance management for physical assets. The first one contains (active and archived) work reports, new work orders, allows dispatching crews, whereas GIS is used to optimize maintenance operations through the spatial view on the assets.

Each system comes with specific tools and applications, which allow users to modify the underlying data sets, both for an initial setup and continuous updates. Furthermore, the applications have different access technologies to their data stores: SQL, OPC, file import/export, and others.

Since the responsibility for the systems lies in the corresponding departments (SCADA—operations, CMMS/GIS—maintenance), changes to the data set of those systems are done through a manual process, e.g., using paper, phone, or e-mail between responsible persons in the departments. This process is error-prone, and leaves the utilities with incorrect data sets with their applications.

Depending on the attributes of an entity in one of the IT systems, the overall system behavior should be adapted accordingly. Today, this cannot be achieved since the changes of attributes in one of the IT systems are not known to other applications.

### DESCRIPTION OF THE INVENTION

It is an object of the invention to reduce malfunctions of utility IT systems due to inconsistent data.

This is achieved with a method for validating consistency of attributes of entities stored in data sets of a multitude of different IT systems according to claim 1.

The inventive method allows validating consistency of attributes of an entity in one of the participating applications. Any inconsistency can be propagated to all other participating applications which then may trigger functionality accordingly.

Attribute consistency works on the comparison of a reference value against the online value of the attributes, which are retrieved from the corresponding system. In order to know which attributes need to be considered for consistency, a list of relevant attributes of each entity type in each application may be stored together with the reference value of the entity. This attribute list is used by the consistency service. Therefore several attribute values of one entity in one system can be included in a combined “hash” value. At start-up or in the engineering phase, this reference value is computed out of the defined attribute list. At the time of a consistency check, the values of the attributes are read and a “hash” value is calculated with the same algorithm as the reference value. If those two values differ, an inconsistency occurred.

External applications relying on those data sets, such as navigation or data synchronization, can therefore adapt accordingly e.g., navigation changes the corresponding GUI screen or data exchange blocks any synchronization attempts to an entity.

The consistency check is executed either before a functionality is triggered, used by applications such as navigation (e.g. navigate to the transformer from SCADA to CMMS), or continuously, to check the consistency on the relations stored in the external data store.

With the inventive method, the consistency of data stored in various IT systems can be checked prior to attempting to access it. This allows offering a certain service or functionality of an application only if the required data is consistently available. Errors by calling a service or functionality that would require access to data that is not available or that is inconsistent are therefore avoided.

Maintenance of the data structure is simplified, since the consistency check easily allows identifying and resolving missing or conflicting data.

Existing applications are not to be modified since a polling mechanism through adapters is used to acquire the needed information from the applications.

Since the relationships are stored in an external database, the consistency check can be used for several applications, such as navigation or data access.

Furthermore, the number of participating applications is not limited. Adding additional IT systems to the consistency validating service only requires extending the reference model stored in the consistency service reference database.

### BRIEF DESCRIPTION OF THE DRAWINGS

The invention will be explained in more detail in the following text with reference to the attached drawings, in which:

FIG. 1 shows the setup of the consistency validating system,

FIG. 2 shows a detailed block diagram of the functionality of the inventive system shown in FIG. 1,

FIG. 3 shows a detailed block diagram of an additional functionality of the inventive system of FIG. 1, and

FIG. 4 shows the setup of a reference container used in the consistency validating system of FIG. 1.

### DETAILED DESCRIPTION OF PREFERRED EMBODIMENTS

A service which knows about the relationships of the entity attributes allows external applications, such as navigation or data access to perform a consistency check before functionality is triggered, or the consistency is checked continuously on the relations stored in the external data store.

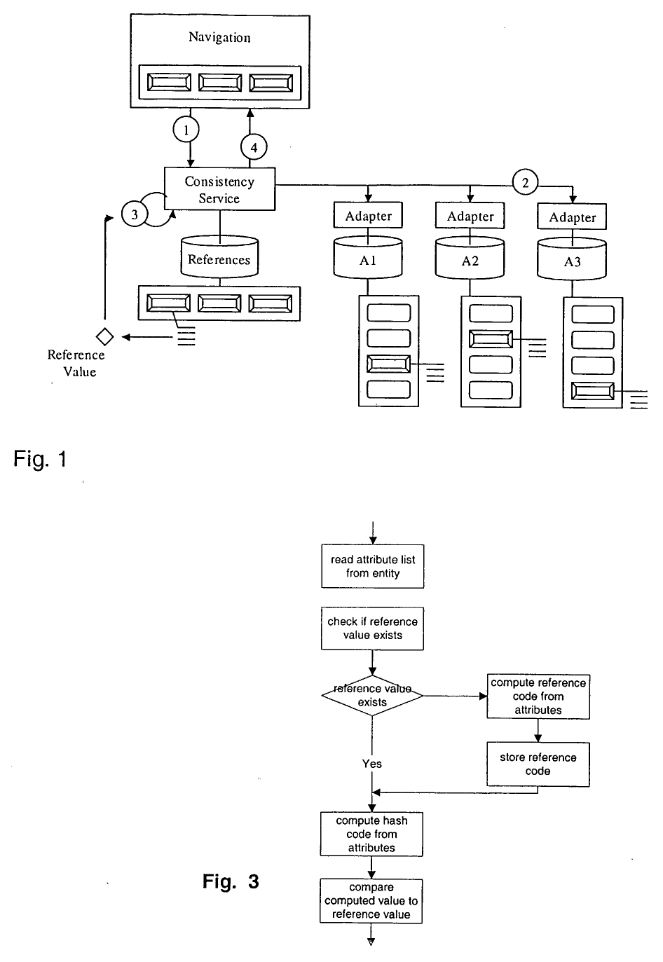

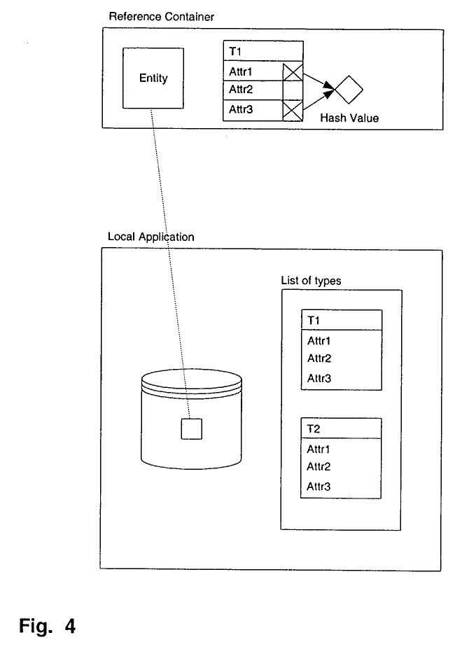

The setup of a validating system for consistency is shown in FIG. 1. An external storage stores a collection of reference containers, which holds a reference model of entities in the different IT systems. The reference container setup is shown in more details in FIG. 4. Entities are assigned to entity types, which hold a list of available attributes. Each entity type can be assigned a critical list of attributes for attribute consistency. If access to a certain entity of a specific IT system is required, that entity can be addressed and details about the entity and its attributes can be retrieved from the IT system. There are adapters to each IT system that allow pinging the data set. A signal sent to the IT systems to verify the existence of a specific data set is sent back by the adapters if the specific data set exists. Otherwise no signal is sent, thus indicating that the data set is missing.

For further enhancing the consistency check, different flags can be applied to an entity or to one of its attributes, e.g., an access flag which defines if the entity can be modified (read/write) or viewed only (read-only). These flags are typically modified through user interactions.

The inventive system comprises a consistency service with an input buffer, output means and communication means to communicate with the adapters of the various IT systems.

An external application registers at the consistency service to be notified on consistency feedback. This calling application can place an entity for which the consistency must be ensured in the buffer, and will get notified as soon as the entity has been processed by the service.

In another approach, a batch application can place a set of entities, or relationships, as defined in the external data store, into the buffer for cyclic checks. No callbacks from the service are triggered. Instead, inconsistent data sets are logged by the service in order to include those in a re-engineering process.

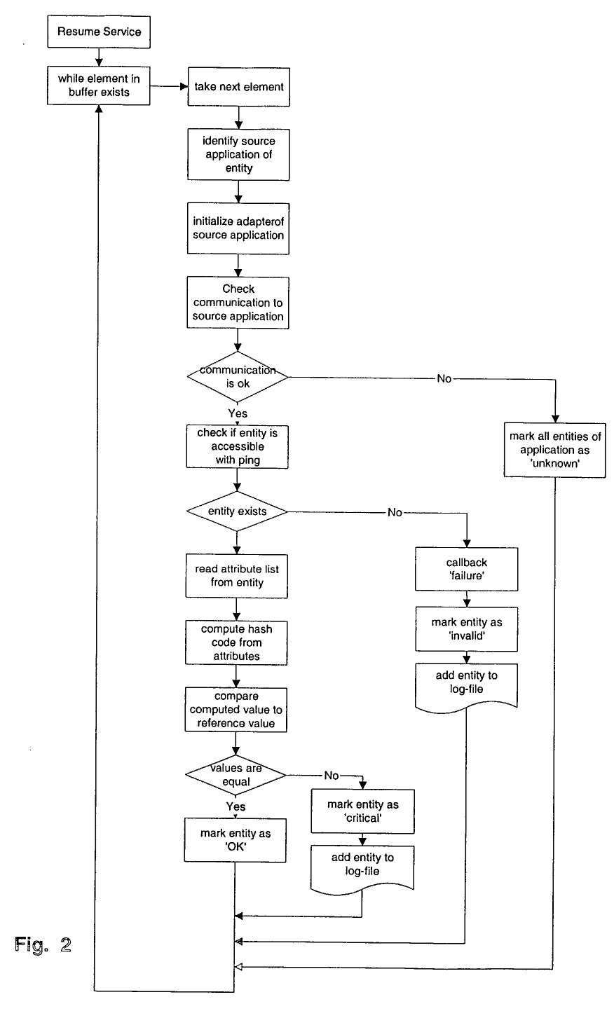

The consistency service fulfills the following functionality (see FIG. 2):

As soon as there is an element in the input buffer, that element is taken (1) and the appropriate source application of that element is identified. For that purpose, entities from different source applications are grouped into a reference container during the engineering phase. The entities carry meta-information, such as its local identifier in order to access the entity in the local application, and an application identifier which allows the consistency service to direct any requests related to that entity to the correct adapter. The adapter of the IT system to be checked is initialized. Then the communication to the source application is checked by sending a service request (e.g. ping the machine the application is residing on, with defined return values: system: UP, entity: EXISTS) to the source applications. If the communication is not properly working, all entities of the application are marked as unknown. Otherwise, the entity that is to be verified is pinged by sending out a signal as described above (2). If the entity does exist and a return signal is sent back accordingly, the attributes are read from the entity according to the attribute list of the entity type to which the entity is assigned. From the attributes read a hash code is computed and compared to the reference hash code stored in the consistency service (3). If the two values are equal, an OK can be loaded into the output means of the consistency service (4). The calling application gets the OK and knows that the requested entity is available with all its attributes being consistent according to the reference entity. If the values differ, the output means and the calling application will get a ‘critical’ failure signal. In addition, a log file will be updated by adding details about the non-consistent entity.

In addition, prior to comparing the computed hash code to the reference value, the existence of the reference code can be checked by the consistency service as shown in FIG. 3. If there is no reference value stored, it can be computed from the attributes just read from the entity in one of the IT systems and is stored with the reference container. This newly computed hash value will then be used as new reference value in order to check consistency of attributes.

1. Method for validating consistency of attributes of entities stored in data sets of a multitude of different IT systems,
whereas entities are assigned to entity types, said entity types holding a list of available attributes,
whereas a consistency service comprises
an input buffer in which an entity to be validated for consistency of its attributes can be placed,
output means in which the result of the consistency validation can be stored and
communication means to communicate with the different IT systems,
whereas an adapter for each of the IT systems allows communication between the consistency service and the IT systems, such that a signal sent by the consistency service to verify the existence of a specific data set of an IT system can be sent back to the consistency service if that specific data set exists, and
whereas a storage device holds references to the entity in the data sets of the various IT systems such that the entity in a specific IT system can be addressed, said method comprising the following steps:
loading the entity to be validated for consistency of its attributes into the buffer of the consistency service,
reading the values of the attributes of the entity from the adapter,
comparing the values of the attributes to values of reference attributes stored in the consistency service, and
storing consistency validating information in the output means, said consistency validating information depending on the results of the comparison of the values of the attributes to the values of the reference attributes.

2. Method as in claim 1, whereas a hash code is computed from the values of the attributes read from the adapter and compared to a reference hash code computed from the values of the reference attributes, and the values of the attributes are compared to the values of the reference attributes by comparing the computed hash codes.

3. Method as in claim 1, further comprising the following step:
the consistency service sending a signal to verify the existence of a specific data set of an IT system to the IT system holding the entity to be validated for consistency of its attributes prior to reading the values from the attributes of the entity from the adapter, and
aborting the consistency validating of the entity if the signal is not being sent back to the consistency service.

4. Method as in claim 3, further comprising the following step:
logging failure of consistency validation if the signal is not being sent back to the consistency service by adding entity, which was to be validated for consistency, and the IT system, which was not replying to the signal, to a log file.

5. Method as in claim 3, further comprising the following step:
the consistency service checking communication to the IT system holding the data set to be verified prior to sending signal to verify the existence of the specific data set of that IT system.

6. Method as in claim 1, further comprising the following step:
a multitude of entities to be validated for consistency being loaded into the buffer of the consistency service,
the consistency service successively processing the entities to be validated for consistency, sending out signals and storing consistency validating information in the output means.

7. A computer program product loadable into an internal memory of a digital computer, comprising computer program code means to make, when said program is loaded in the computer, the computer execute the method of any of claim 1.

8. Consistency validating System for validating consistency of entities stored in data sets of a multitude of different IT systems, said system comprising a consistency service with
an input buffer in which an entity to be validated for consistency can be placed,
output means in which the result of the consistency validation can be stored and
communication means to communicate with the different IT systems, whereas an adapter for each of the IT systems allows communication between the consistency service and the IT systems, such that a signal sent by the consistency service to verify the existence of a specific data set of an IT system can be sent back to the consistency service if that specific data set exists, and
whereas a reference storage device holds references to the entities in the data sets of the various IT systems such that a specific entity in a specific IT system can be addressed based on such a reference stored in the reference storage.

9. Consistency validating System as in claim 8, wherein the reference storage further holds entity types, to which each entity can be assigned, said entity types defining a list of available attributes of the entities.

10. Consistency validating System as in claim 9, wherein the reference storage further holds a reference hash code for each entity type computed from the values of the attributes of a reference entity.
